(19) United States
(12) Patent Application Publication
(10) Pub. No.: US 2024/0144658 A1
(43) Pub. Date: May 2, 2024

(54) SYSTEM FOR TRAINING AND VALIDATING VEHICULAR OCCUPANT MONITORING SYSTEM

(71) Applicant: Magna Electronics Inc., Auburn Hills, MI (US)

(72) Inventor: Anuj S. Potnis, Hosbach (DE)

(21) Appl. No.: 18/497,045

(22) Filed: Oct. 30, 2023

Related U.S. Application Data
(60) Provisional application No. 63/381,987, filed on Nov. 2, 2022.

(51) Int. Cl. G06V 10/774; B60R 1/12; B60R 16/023; G06V 20/59; G06V 40/10

(52) U.S. Cl. CPC G06V 10/774; B60R 1/12; B60R 16/0231; G06V 20/59; G06V 40/10; B60R 1/04

(57) ABSTRACT

A method for training a vehicular occupant monitoring system includes accessing a frame image data captured by a camera disposed at a vehicle and viewing an occupant present in the vehicle. A first artificial visual characteristic for the occupant is generated. A first modified frame of image data is generated that includes the accessed frame with the first artificial visual characteristic overlaying a first portion of the occupant. A second artificial visual characteristic is generated for the occupant. The second artificial visual characteristic is different than the first artificial visual characteristic. A second modified frame of image data is generated that includes the accessed frame with the second v artificial visual characteristic overlaying a second portion of the occupant. The vehicular occupant monitoring system is trained using the first modified frame of image data and the second modified frame of image data.

### CROSS REFERENCE TO RELATED APPLICATION

The present application claims the filing benefits of U.S. provisional application Ser. No. 63/381,987, filed Nov. 2, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A method for training a vehicular occupant monitoring system includes accessing a frame of image data captured by a camera disposed at a vehicle and viewing at least a portion of an occupant present in the vehicle. The method includes generating a first artificial visual characteristic for the occupant and generating a first modified frame of image data. The first modified frame of image data includes the accessed frame of the image data modified to include the first artificial visual characteristic overlaying a first portion of the occupant. The method includes generating a second artificial visual characteristic for the occupant. The second artificial visual characteristic is different than the first artificial visual characteristic. The method includes generating a second modified frame of image data. The second modified frame of image data includes the accessed frame of image data modified to include the second artificial visual characteristic overlaying a second portion of the occupant. The method also includes training the vehicular occupant monitoring system using (i) the accessed frame of image data, (ii) the first modified frame of image data and (iii) the second modified frame of image data.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates at least one camera;

FIG. 2 is a perspective view of an interior rearview mirror assembly, showing a camera and light emitters behind the reflective element; and

FIG. 3 is a block diagram of the vision system of FIG. 1.

### DESCRIPTION OF THE PREFERRED EMBODIMENTS

A vehicle vision system and/or driver monitoring system (DMS) and/or occupant monitoring system (OMS) and/or alert system operates to capture data of an interior of the vehicle and may process the data to detect objects within the vehicle. The system includes a processor or processing system that is operable to receive data from one or more sensors.

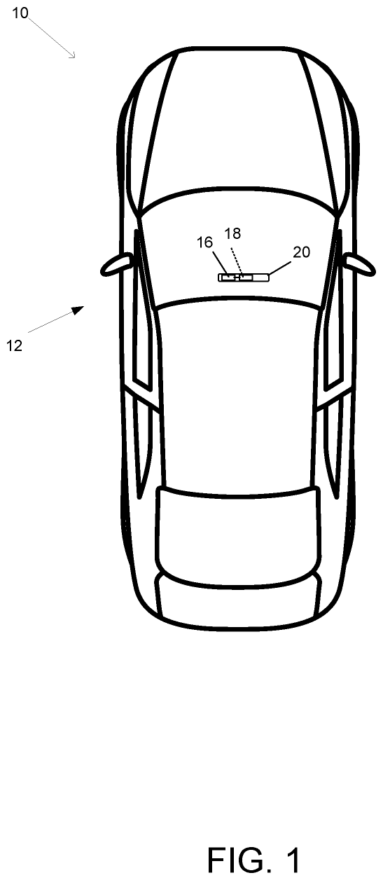

Referring now to the drawings and the illustrative embodiments depicted therein, a vehicle 10 includes a vision system or driver monitoring system 12 that includes at least one interior viewing imaging sensor or camera, such as a rearview mirror imaging sensor or camera 16 (FIG. 1). Optionally, an interior viewing camera may be disposed at the windshield of the vehicle. The vision system 12 includes a control or electronic control unit (ECU) 18 having electronic circuitry and associated software, with the electronic circuitry including a data processor or image processor that is operable to process image data captured by the sensor or camera or cameras, whereby the ECU may detect or determine presence of objects or the like (although shown in FIG. 1 as being part of or incorporated in or at an interior rearview mirror assembly 20 of the vehicle, the control and/or the display device may be disposed elsewhere at or in the vehicle). The data transfer or signal communication from the sensor or camera to the ECU may comprise any suitable data or communication link, such as a vehicle network bus or the like of the equipped vehicle.

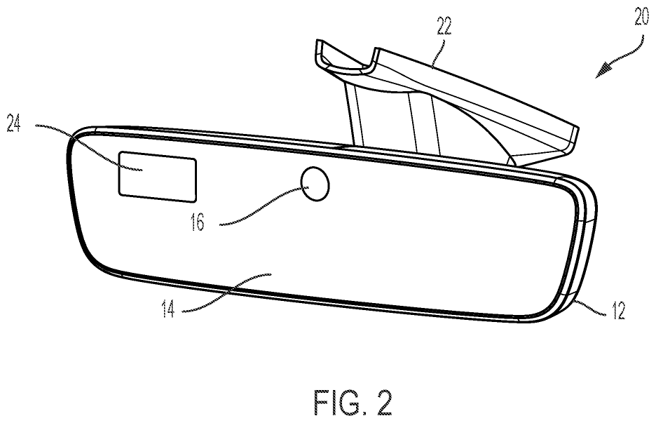

The vision system may incorporate a driver monitoring system (DMS) and/or occupant monitoring system (OMS) that uses one or more cameras placed near or at or within the rearview mirror assembly (e.g., behind the glass of the rearview mirror). As shown in FIG. 2, the mirror assembly 20 may include or may be associated with a DMS/OMS, with the mirror assembly comprising a driver/occupant monitoring camera 16 disposed at a back plate (and viewing through an aperture of the back plate) behind the reflective element 14 and viewing through the reflective element toward at least a head region of a driver present in the vehicle. The DMS includes a near infrared light emitter 24 disposed at the back plate and emitting light through another aperture of the back plate and through the reflective element.

With the DMS camera disposed in the mirror head 12, the camera moves with the mirror head (including the mirror casing and mirror reflective element that pivot at a pivot joint that pivotally connects the mirror head to the mounting structure 22 of the interior rearview mirror assembly that in turn mounts at a windshield or at a headliner of the equipped vehicle), such that, when the driver aligns the mirror to view rearward, the camera views the driver present in the vehicle. The location of the DMS camera and the near IR LED(s) at the mirror head provide an unobstructed view to the driver. The DMS preferably is self-contained in the interior rearview mirror assembly and thus may be readily implemented in a variety of vehicles. The driver monitoring camera may also provide captured image data for an occupancy monitoring system (OMS) or another separate camera may be disposed at the mirror assembly for the OMS function.

The mirror assembly includes a printed circuit board (PCB) having a control or control unit comprising electronic circuitry (disposed at the circuit board or substrate in the mirror casing), which includes driver circuitry for controlling dimming of the mirror reflective element. The circuit board (or a separate DMS circuit board) includes a processor that processes image data captured by the camera 16 for monitoring the driver and determining, for example, driver attentiveness and/or driver drowsiness. The driver monitoring system includes the driver monitoring camera and may also include an occupant monitoring camera (or the driver monitoring camera may have a sufficiently wide field of view so as to view the occupant or passenger seat of the vehicle as well as the driver region), and may provide occupant detection and/or monitoring functions as part of an occupant monitoring system (OMS).

The mirror assembly may also include one or more infrared (IR) or near infrared light emitters 24 (such as IR or near-IR light emitting diodes (LEDs) or vertical-cavity surface-emitting lasers (VCSEL) or the like) disposed at the back plate behind the reflective element 14 and emitting near infrared light through the aperture of the back plate and through the reflective element toward the head region of the driver of the vehicle. The camera and near infrared light emitter(s) may utilize aspects of the systems described in International Publication No. WO 2022/187805 and/or International Application No. PCT/US2022/072238, filed May 11, 2022, which are hereby incorporated herein by reference in their entireties.

Many DMS and/or OMS functions require training and validation of the system by collecting data with a large variety/distribution of driver types/categories (e.g., ethnic group, gender, age group, height, eye type, etc.). Moreover, for each of these categories, the training data requires further variations on appearance (e.g., beards, hats, caps, tattoos, etc.). This results in an extremely large number of combinations, which at best is time-consuming and expensive to collect, and at worst is impossible to collect.

Conventional technologies propose using synthetic data to solve this problem. Using sophisticated face and facial expression scanning devices, videos may be collected and later post-processed to form a corresponding synthetically generated video. The advantage here is that many different looking people can be created. However, synthetic data has its limitations. For example, synthetic data may not replicate the biological aspects of the face with the level of accuracy required for the system to function. Specifically, skin textures, eyes, pupil dilation to lighting, blinking of the eyes, gaze etc., may be difficult to accurately generate. These differences may influence training of the models, causing the models to be less accurate when operating on real world image data.

Implementations herein include a hybrid approach for generating videos for training systems reliant on image data, such as DMS and OMS functions. The videos are a hybrid between real videos and synthetic images. In this approach, systems and methods isolate skin, facial expressions, and/or eyes from external “add-ons” such as beards, hats, caps, eyeglasses, sunglasses, jewelry, tattoos, etc. This is achieved by recording a base video (i.e., “real video”) and then accurately projecting/overlaying synthetic add-ons (i.e., artificial visual characteristics) onto the original base real video recordings.

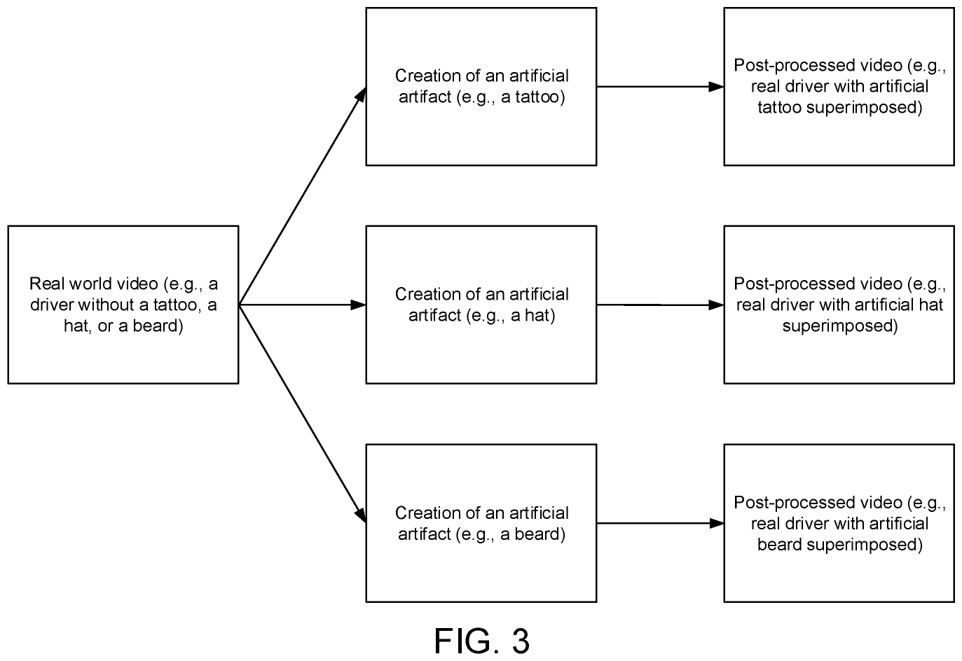

Referring now to FIG. 3, the system and/or method generates training data for vision systems (e.g., OMS and DMS) by projecting synthetic visual data on top of recorded image data. That is, synthetic visuals are overlaid on base recordings (captured using a vehicular interior camera and accessed via an application) of at least a portion of a driver (e.g., the hands and/or face of the driver) or other occupant of the vehicle. The base recordings are collected during “real world” driving of the vehicle. For example, a driver and/or other occupant with little to no “add-ons” (e.g., beards, hats, visible tattoos, glasses, jewelry, etc.) is recorded for a period of time while driving/occupying the vehicle. After recording the data, the training method includes modifying the recorded video to superimpose add-ons onto the image data representative of the driver or occupant. For example, a tattoo may be superimposed on the face or hands of the occupant captured in the original data, a hat may be superimposed on hair of the occupant, a beard may be superimposed on a face of the occupant, etc. This same base recording may be used to generate many versions of modified recordings by superimposing many add-ons and in any combination. That is, each frame of the recorded based image data may be reused for superimposing any combination of add-ons. For example, one version of the modified recording may include the driver with a superimposed tattoo, a second version of the modified recording may include the driver with a superimposed hat, while a third version of the modified recording may include the driver with the superimposed tattoo and the superimposed hat. Other versions may include multiple add-ons simultaneously (such as a superimposed hat and a superimposed beard).

The potential add-ons may be sorted into different categories (e.g., a beard category, a hat category, etc.). Each category may have any number of variations for the category. For example, the hat category may have a number of different hats with different shapes and/or colors. The base video data may be superimposed with different variations for each category of add-ons. The synthetic add-ons may be processed to better match the base image the synthetic add-on is superimposed upon. For example, the synthetic add-ons may be processed to better adapt to various light conditions present in the base video. For instance, a synthetic hat may be darkened for low light conditions to match the rest of the base video.

Each synthetic add-on may be “overlaid” or otherwise superimposed onto frames of captured image data. The synthetic add-ons may be manually added to one or more frames of image data via a human operator (e.g., using photo-editing software). In other examples, the synthetic add-ons are automatically added via an application or program with access to the recorded sensor data. For example, an application executing on a user device, the vehicle, or a server in communication with a user device accesses the recorded sensor data and overlays one or more synthetic add-ons to frames of the image data. The program may classify or categorize different portions of each frame of image data (e.g., using a machine learning model or the like). For example, the program may classify a driver's hair, eyes, mouth, etc. The program may overlay the add-ons based at least partially on the classification of the base image data.

Any number of OMS/DMS/vision system functions may be trained using the modified image data (i.e., frames of image data overlaid with one or more synthetic add-ons). For example, one or more machine learning models may be trained using the modified image data, allowing the model to be trained on a much wider and deeper variety of driver appearances while maintaining the general quality of real world image data without the costs associated with acquiring such variety in the data. For example, a model could be trained on a recording of base image data, a recording of the base image data with a first synthetic add-on, and a recording of the base image data with a second synthetic add-on, which greatly expands the pool of training data for the model without requiring the acquisition of any additional based image data.

Thus, the systems and/or methods herein generate hybrid or modified image data for training vision models, such as for DMS and OMS functions. Existing technology uses (i) real-world captured image data, which is expensive and time-consuming to obtain in the quantities and variety required for quality training or (ii) synthetic images that fail to be sufficiently biologically accurate for quality training of the functions. The hybrid system decouples aspects difficult to simulate (e.g., eyes) from other aspects that are simpler to simulate (e.g., hair) and/or artificial aspects (e.g., tattoos and hats). This allows for more accurate representation of real-word scenarios while producing large datasets with low cost and effort. Systems trained with this data will have more training and/or validation data available (with less data collection effort) to cover a wider variety of scenarios and will allow for more reliable testing of systems.

The ECU may be located at or within the interior rearview mirror assembly, such as in the mirror head or the mirror base. Optionally, the ECU may be located remote from the interior rearview mirror assembly. If the ECU is located remote from the interior rearview mirror assembly, the image data captured by the camera may be transferred to the ECU (and optionally control signals and/or electrical power from the ECU may be transferred to the camera) via a coaxial cable, such as by utilizing aspects of the systems described in U.S. Pat. Nos. 11,792,360; 11,638,070; 11,533,452; 11,508,160; 11,308,718; 11,290,679; 11,252,376; 11,201,994; 11,025,859; 10,922,563; 10,827,108; 10,694,150; 10,630,940; 10,567,705; 10,567,633; 10,515,279; 10,284,764; 10,089,537; 10,071,687; 10,057,544 and/or 9,900,490, which are all hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The camera and system may be part of or associated with a driver monitoring system (DMS) and/or occupant monitoring system (OMS), where the image data captured by the camera is processed to determine characteristics of the driver and/or occupant/passenger (such as to determine driver attentiveness or drowsiness or the like). The DMS/OMS may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2022/241423; WO 2022/187805 and/or WO 2023/034956, and/or PCT Application No. PCT/US2023/021799, filed May 11, 2023 (Attorney Docket DON01 FP4810WO), which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Changes and modifications in the specifically described embodiments can be carried out without departing from the principles of the invention, which is intended to be limited only by the scope of the appended claims, as interpreted according to the principles of patent law including the doctrine of equivalents.

1. A method for training a vehicular occupant monitoring system, the method comprising:
accessing a frame of image data captured by a camera disposed at a vehicle and viewing at least a portion of an occupant present in the vehicle;
generating a first artificial visual characteristic for the occupant;
generating a first modified frame of image data, wherein the first modified frame of image data comprises the accessed frame of the image data modified to include the first artificial visual characteristic overlaying a first portion of the occupant;
generating a second artificial visual characteristic for the occupant, wherein the second artificial visual characteristic is different than the first artificial visual characteristic;
generating a second modified frame of image data, wherein the second modified frame of image data comprises the accessed frame of image data modified to include the second artificial visual characteristic overlaying a second portion of the occupant; and
training the vehicular occupant monitoring system using (i) the accessed frame of image data, (ii) the first modified frame of image data and (iii) the second modified frame of image data.

2. The method of claim 1, wherein the first artificial visual characteristic comprises at least one selected from the group consisting of (i) a hat, (ii) a beard and (iii) a tattoo.

3. The method of claim 1, wherein the first artificial visual characteristic and the second artificial visual characteristic each comprise synthetic image data.

4. The method of claim 1, wherein the first artificial visual characteristic and the second artificial visual characteristic do not overlay the eyes of the occupant.

5. The method of claim 1, wherein training the vehicular occupant monitoring system comprises training a machine learning model of the vehicular occupant monitoring system.

6. The method of claim 1, further comprising generating third modified image data, wherein the third modified image data comprises the accessed frame of image data with the first artificial visual characteristic and the second artificial visual characteristic each overlaying a respective portion of the occupant.

7. The method of claim 1, wherein the first portion of the occupant comprises one selected from the group consisting of (i) hands of the occupant, (ii) hair of the occupant and (iii) the face of the occupant.

8. The method of claim 1, wherein the first portion of the occupant and the second portion of the occupant are the same.

9. The method of claim 1, wherein the first portion of the occupant and the second portion of the occupant are different.

10. The method of claim 1, wherein accessing the image data captured by the camera disposed at the vehicle comprises recording the image data using the camera while the camera is disposed at the vehicle.

11. The method of claim 1, wherein the camera is disposed at an interior rearview mirror assembly of the vehicle.

12. The method of claim 11, wherein the camera is disposed within a mirror head of the interior rearview mirror assembly of the vehicle, and wherein the camera views through a mirror reflective element of the mirror head of the interior rearview mirror assembly of the vehicle.

13. The method of claim 11, wherein image data captured by the camera is processed by an ECU, and wherein the ECU is disposed at the interior rearview mirror assembly of the vehicle.

14. The method of claim 11, wherein image data captured by the camera is processed by an ECU, and wherein the ECU is disposed at the vehicle remote from the interior rearview mirror assembly.

15. The method of claim 14, wherein image data captured by the camera is transferred to the ECU via a coaxial cable.

16. The method of claim 1, wherein image data captured by the camera is processed by an ECU, and wherein the ECU is operable to process the image data for at least one driving assist system of the vehicle.

17. The method of claim 1, wherein the occupant of the vehicle is a driver of the vehicle and the vehicular occupant monitoring system comprises a vehicular driver monitoring system.

18. The method of claim 1, wherein the occupant of the vehicle is a passenger of the vehicle and the vehicular occupant monitoring system comprises a vehicular occupant detection system.

19. A method for training a vehicular occupant monitoring system, the method comprising:
accessing a frame of image data captured by a camera disposed at a vehicle and viewing at least a portion of an occupant present in the vehicle;
generating a first artificial visual characteristic for the occupant;
generating a first modified frame of image data, wherein the first modified frame of image data comprises the accessed frame of the image data modified to include the first artificial visual characteristic overlaying a first portion of the occupant;
wherein at least one selected from the group consisting of (i) the first artificial visual characteristic comprises a hat and the first portion of the occupant comprises hair of the occupant, (ii) the first artificial visual characteristic comprises a beard and the first portion of the occupant comprises the face of the occupant and (iii) the first artificial visual characteristic comprises a tattoo and the first portion of the occupant comprises one selected from the group consisting of (a) hands of the occupant and (b) the face of the occupant;
generating a second artificial visual characteristic for the occupant, wherein the second artificial visual characteristic is different than the first artificial visual characteristic;
generating a second modified frame of image data, wherein the second modified frame of image data comprises the accessed frame of image data modified to include the second artificial visual characteristic overlaying a second portion of the occupant; and
training the vehicular occupant monitoring system using (i) the accessed frame of image data, (ii) the first modified frame of image data and (iii) the second modified frame of image data.

20. The method of claim 19, wherein the first artificial visual characteristic and the second artificial visual characteristic each comprise synthetic image data.

21. The method of claim 19, wherein training the vehicular occupant monitoring system comprises training a machine learning model of the vehicular occupant monitoring system.

22. The method of claim 19, wherein the first portion of the occupant and the second portion of the occupant are the same.

23. The method of claim 19, wherein the first portion of the occupant and the second portion of the occupant are different.

24. A method for training a vehicular occupant monitoring system, the method comprising:
recording a frame of image data using a camera disposed at a vehicle and viewing at least a portion of an occupant present in the vehicle;
generating a first artificial visual characteristic for the occupant;
generating a first modified frame of image data, wherein the first modified frame of image data comprises the recorded frame of the image data modified to include the first artificial visual characteristic overlaying a first portion of the occupant;
generating a second artificial visual characteristic for the occupant, wherein the second artificial visual characteristic is different than the first artificial visual characteristic, and wherein the first artificial visual characteristic and the second artificial visual characteristic each comprise synthetic image data;
generating a second modified frame of image data, wherein the second modified frame of image data comprises the recorded frame of image data modified to include the second artificial visual characteristic overlaying a second portion of the occupant; and
training the vehicular occupant monitoring system using (i) the recorded frame of image data, (ii) the first modified frame of image data and (iii) the second modified frame of image data.

25. The method of claim 24, wherein the first artificial visual characteristic comprises at least one selected from the group consisting of (i) a hat, (ii) a beard and (iii) a tattoo.

26. The method of claim 24, wherein the first artificial visual characteristic and the second artificial visual characteristic do not overlay the eyes of the occupant.

27. The method of claim 24, wherein training the vehicular occupant monitoring system comprises training a machine learning model of the vehicular occupant monitoring system.
